(19) United States
(12) Patent Application Publication
(10) Pub. No.: US 2014/0143947 A1
(43) Pub. Date: May 29, 2014

(54) Self-Administered Bedpan

(71) Applicant: David Levy, Berkeley, CA (US)

(72) Inventor: David Levy, Berkeley, CA (US)

(21) Appl. No.: 14/113,376

(22) PCT Filed: Apr. 23, 2012
(86) PCT No.: PCT/US12/34724

§ 371 Date: Jan. 27, 2014

Related U.S. Application Data
(60) Provisional application No. 61/478,547, filed on Apr. 24, 2011.

(51) Int. Cl. A61G 9/00

(52) U.S. Cl. CPC A61G 9/003
USPC 4/451; 4/450

(57) ABSTRACT

The present invention relates to self-administered bedpans that may be utilized without assistance from a second party. In one embodiment, a self-administered bedpan includes a waste reservoir and one or more handles. The reservoir includes an opening extending above an anus of the user, and extending below a sacrum of the user. The handle is configured to be grasped by the user and can be further adapted to a plurality of orientations with respect to the bedpan thereby enabling the bedpan to be compatible with a plurality of user arm lengths.

### BACKGROUND

The present invention relates to bedpans. More particularly, the invention relates to bedpans that may be utilized without assistance from a second party.

Bedpans have been used in various forms for many years. They facilitate the collection and disposal of bodily waste for persons confined to bed. Traditionally, the process requires an assistant to place and remove the bedpan. Because the elimination of bodily waste is a private activity for everyone except young children, requiring assistance to perform this basic function as an adult is embarrassing. More importantly, many people feel a loss of dignity and control at a time when illness and/or infirmity has already taken a mental toll. Furthermore, the need to have assistance to perform this basic bodily function either: 1) places a sleep burden on a loved one or 2) creates a financial burden to have expensive off-hours professional assistance. One of the problems with existing bedpans are that oftentimes the user may take a long period to defecate, requiring the pan to remain in position for long periods of time, which is uncomfortable and may cause medical complications. Furthermore, the process is known to be odiferous. Yet still further, is difficult for some people to produce bodily waste while lying down because it is an unfamiliar position. Yet still further, moving a bedpan can be problematic because of the risk of spillage.

It is therefore desirable to improve the ability for persons with reduced mobility or immobility to eliminate bodily waste without assistance for economic and personal reasons. It is desirable to provide means so that bedpans do not need to be left under the patient, for long periods of time. It is desirable to prevent odors from entering the bed/sleeping area. It is desirable to make it easier for people to produce bodily waste while lying down. It is desirable to reduce the risk of spillage especially for a person operating a bedpan without assistance. Finally, it is desirable to provide these advantages with a low-cost and compact device.

### SUMMARY

To achieve the foregoing and in accordance with the present invention, self-administered bedpans that may be utilized without assistance from a second party, are provided.

In one embodiment, a self-administered bedpan includes a reservoir and at least one handle. The reservoir is configured to receive bodily waste of a user. The reservoir includes an opening configured to extend above an anus of the user and further configured to extend below a sacrum of the user.

The at least one handle is configured to be grasped by the user and can be further configured to adapt to a plurality of orientations with respect to the bedpan thereby enabling the bedpan to be compatible with a plurality of arm lengths. The at least one handle is configured to allow the user to increase pressure between the bedpan and buttocks of the user by pulling on the at least one handle in a direction substantially towards a head of the user.

In some embodiments, the bedpan includes an urination extension configured to channel urine produced by the user into the reservoir. The bedpan may also include a tilt sensor configured to measure the horizontal orientation of the bedpan.

The bedpan may include a spring-loaded self-closing opening configured to close when the user disengages from the bedpan thereby substantially preventing spillage of waste from the reservoir. The bedpan may also include a latch configured to cause the self-closing opening of the reservoir to remain in an open position, and wherein the latch is further configured to release when the user engages with the bedpan thereby enabling the self-closing opening to close when the user disengages from the bedpan.

In some embodiments, a disposable waste bag is used. The bag opening is disposed around the reservoir opening and may be configured to transition from a substantially open state to a substantially sealed state while the opening of the reservoir is in substantial contact with buttocks of the user. In some embodiments, a tension member, such as a string or elastic is disposed about the bag opening to further constrain the bag to the reservoir opening and/or to affect closure of the bag.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 shows an isometric view of a self administered bedpan with side handles;

FIG. 2 shows an isometric view of a self administered bedpan with reconfigurable side handles;

FIG. 3 shows a disposable bag;

FIG. 4 shows a top view of a bedpan with a bag sealing feature in the open position;

FIG. 5 shows a top view of a bedpan with a bag sealing feature in the closed position;

FIG. 6 shows a top view of a user using self-administered bedpan with two side handles;

FIG. 7 shows a side view of a user using self-administered bedpan with two side handles;

FIG. 8 shows a side view of a self-administered bedpan with a central handle;

FIG. 9 shows a side view of a self-administered bedpan with a central handle and urine collection feature;

FIG. 10 shows a top view of a user using a self-administered bedpan with a central handle;

FIG. 11 shows a side view of a user using a self-administered bedpan with a central handle;

FIG. 12 shows a flow chart of a user using a self-administered bedpan;

FIG. 13 shows a two-part embodiment prior to use; and

FIG. 14 shows the two-part embodiment after use.

Like reference symbols in the various drawings indicate like elements.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

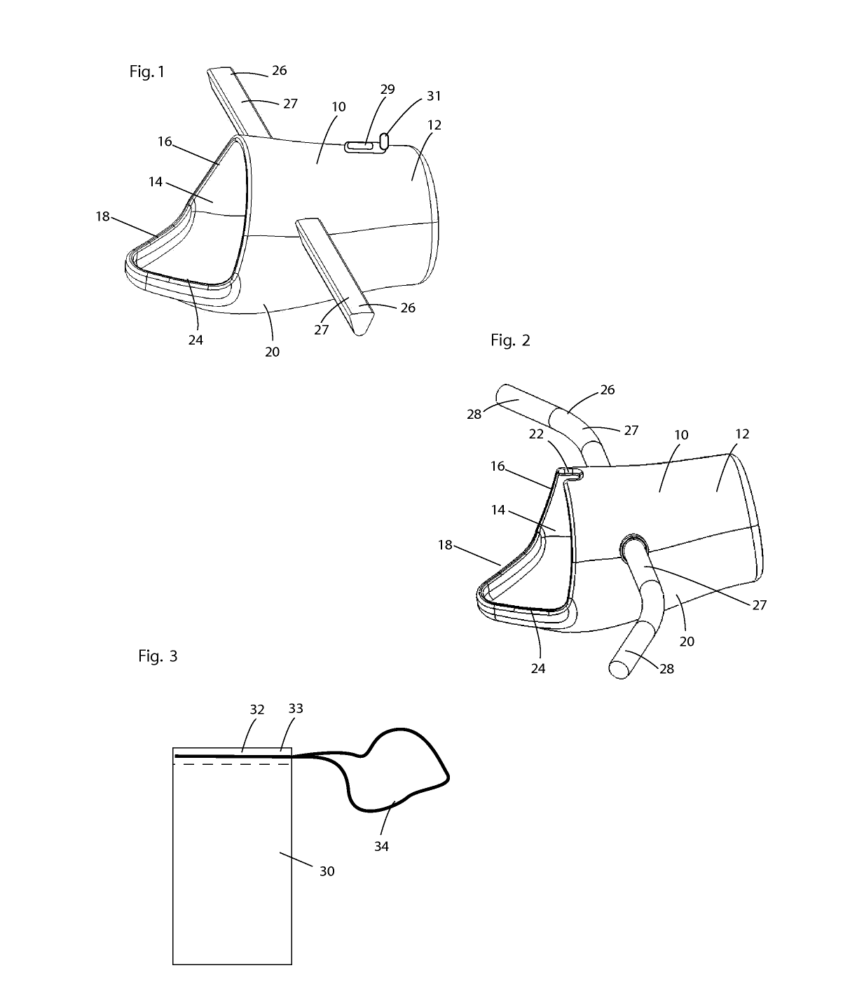

In the present invention, FIG. 1 shows an embodiment of the instant invention in which bedpan 10 includes a reservoir 12, with its primary axis disposed horizontally and an opening 14 that includes two aspects. For descriptive purposes these two aspects may be called the vertical aspect 16 and the horizontal aspect 18. The vertical aspect 16 is the portion of opening 14 oriented predominantly vertically. Vertical aspect 16 is roughly contoured to the human buttocks, providing an entrance to reservoir 12 dimensioned to extend to either side of the anus and above it, whilst the user is lying on his back and the predominant orientation of the anus is horizontal. Horizontal aspect 18 is the portion of opening 14 oriented predominantly horizontally. It extends below the sacrum of the user. In this embodiment, both vertical aspect 16 and horizontal aspect 18 are widest where they meet (near the center of opening 14) and taper to roughly triangular shapes, with their narrowest regions disposed above the anus, and below the sacrum, respectively. The tapering of vertical aspect 16 allows the user's legs to rest comfortably on either side of reservoir 12. The tapering of horizontal aspect 18 minimizes the size of the device, although alternate embodiments need not have a taper. The collection region 20 of reservoir 12 is the lowest area while the device is oriented horizontally and therefore the location where waste materials are most likely to collect. Lip 24 circumnavigates opening 14, including both vertical aspect 16 and horizontal aspect 18. It is preferable for lip 24 to be wider in horizontal aspect 18 to lower the pressure applied to the users' sacrum during use. Handles 26 are disposed along the sides of reservoir 12, such that each may be grasped by one hand of the user while defecating, as shown in FIGS. 6 and 7. A leg-oriented pressure surface 27 is shown integrated into handle 26. The user may alter the angle of bedpan 10 with respect to gravity and/or force collection region 20 downwards, thereby insuring that bodily waste flows toward the area designated for collection of bodily waste such as collection region 20. Because it can be difficult for a use to identify whether or not bedpan 10 is oriented correctly whilst lying on his back, a tilt sensor 29 is used in some embodiments to measure the angle of bedpan 10 with respect to gravity. Tilt sensor 29 may be implemented with an electronic sensor (such as a magneto transistor or accelerometer) or a mechanical means (such as a bubble or weight, or the like). Likewise, these embodiments may include an angular feedback means, such as an audio tone that signals when bedpan 10 is correctly oriented with respect to gravity, or a visual indicator such as a dial, oriented toward the user, which displays a first color when bedpan 10 is incorrectly oriented, and a second color when bedpan 10 is correctly oriented with respect to gravity.

FIG. 2 shows an embodiment including catch 22, disposed at the top of vertical aspect 16. While drawn as a notch, catch 22 may also be a peg, hook or any like feature capable or redirecting a tension member such as a string. FIG. 2 also shows an embodiment in which handles 26 are detachable and may be reattached in a plurality of orientations, thereby altering the orientation of gripping region 28. This modification allows the ergonomics to be optimized for people of different torso to arm length ratios. The figure shows gripping regions 28 biased toward opening 14, a configuration appropriate for persons with relatively short arms.

FIG. 3 shows a disposable bag 30. Bag 30 includes an open end 32, which is dimensioned to correlate with lip 24. In operation, bag 30 rests inside reservoir 12 and open end 32 is temporarily disposed around opening 14. The other dimensions of the bag are designed to fit within reservoir 12. Bag 30 may be made of any thin material such as polyethylene. It is preferably opaque. In one embodiment, bag 30 includes drawstring 34, a portion of which is constrained to a region proximate to open end 32, such as by a reverse fold 33 of the thin material, which may be then bonded to the bag forming a channel to constrain drawstring 34. In one embodiment, the materials are biodegradable, such as a coated paper for the thin material and cotton for drawstring 34.

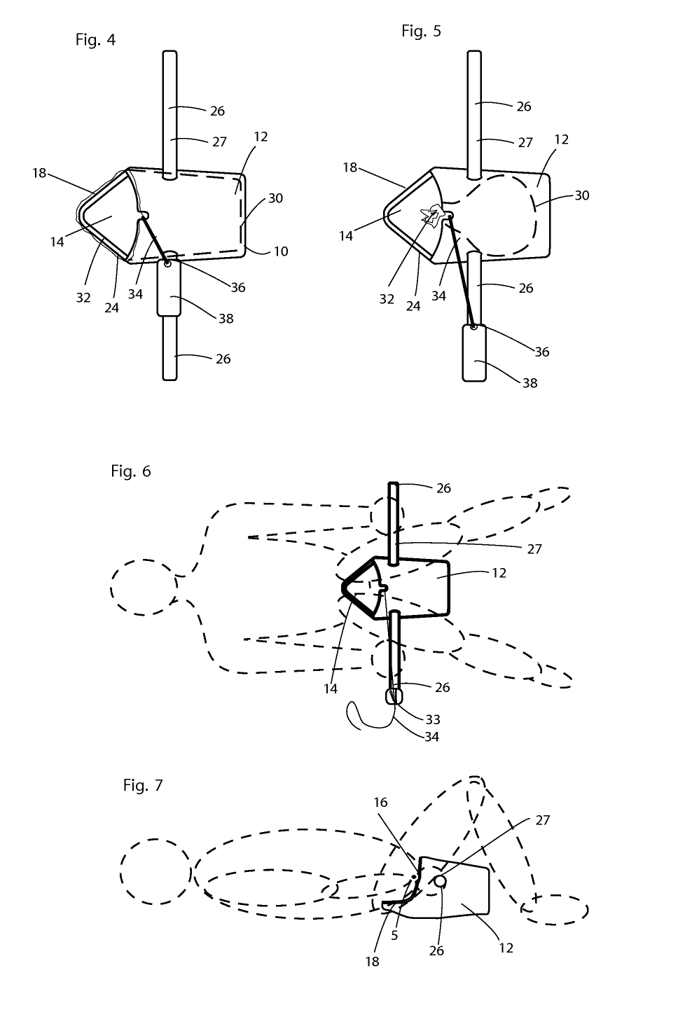

FIG. 4 shows bag 30 (dashed line) disposed within reservoir 12, with open end 32 constrained to opening 14. In this embodiment, drawstring 34 is constrained by catch 22 and temporarily attached to slide catch 36, which is in turn permanently attached to slide-able member 38. This method is convenient because it is in easy matter to install bag 30, slide a portion of drawstring 30 into catch 22 and then attach the end of drawstring 34 to catch 36. In an alternate embodiment, one end of drawstring 34 is held by a ratchet mechanism so that once drawstring 34 is pulled sufficiently to close bag 30, it will remain closed.

FIG. 5 shows the effect of sliding slide-able member 38 along handle 26. Drawstring 34 is pulled tight, thereby collapsing the open end 32 and essentially sealing bag 30, shown with dashed line. Because catch 22 is located above opening 14, no waste material escapes while bag 30 is sealed. The travel distance of slide-able member 38 roughly correlates with the circumference of opening 14. This operation may be done immediately after defecation, while user is still lying down as shown in FIGS. 6 and 7. Because bag 30 is sealed before the bedpan 10 is moved (after bodily waste is deposited), the risk of spillage is decreased. Also, because the bag is sealed while the device is still in contact with the buttocks, the release of odors is vastly reduced.

FIG. 6 shows a user from the top while using bedpan 10. By pulling upwards on handles 26, (toward his own head) the user may easily apply pressure between opening 14 and his own buttocks. This has benefits as follows: First, pressure upon the buttocks simulates the normal seated position and provides a sense of comfort and familiarity, making it easier for a user to produce waste material in the prone position. Second, the pressure between opening 14 and the buttocks creates a seal, and the user has control of the amount of pressure at any given moment, with larger amounts of pressure only at such times as it is needed, either mentally to aid the process, or physically to reduce or eliminate both sound and odor. Additionally, providing the user active involvement in the process, especially at the moment waste is produced provides a strong sense of personal control over this highly private matter. In this embodiment, bag 30 is sealed by using ratchet mechanism 33. After placing bag 30, drawstring 34 is placed within ratchet mechanism 33, such that any slack is removed and the balance of drawstring 34 rests beyond the end of handle 26, where it may be easily seen and grasped by the user while prone. Ratchet mechanism 33 includes a spring-loaded arm that rotates on a pivot such that drawstring 34 may slide easily away from bag 30, but is highly constrained not to move toward bag 30. After defecation, the user pulls drawstring 34 until open end 32 is collapsed (as shown in FIG. 5). Ratchet mechanism 33 maintains tension on drawstring 34, thereby maintaining a seal on bag 30. The user may then move bedpan 10 without concerns of spillage.

FIG. 7 shows a user from the side while using bedpan 10. Anus 5 is disposed approximately in the center of vertical aspect 16.

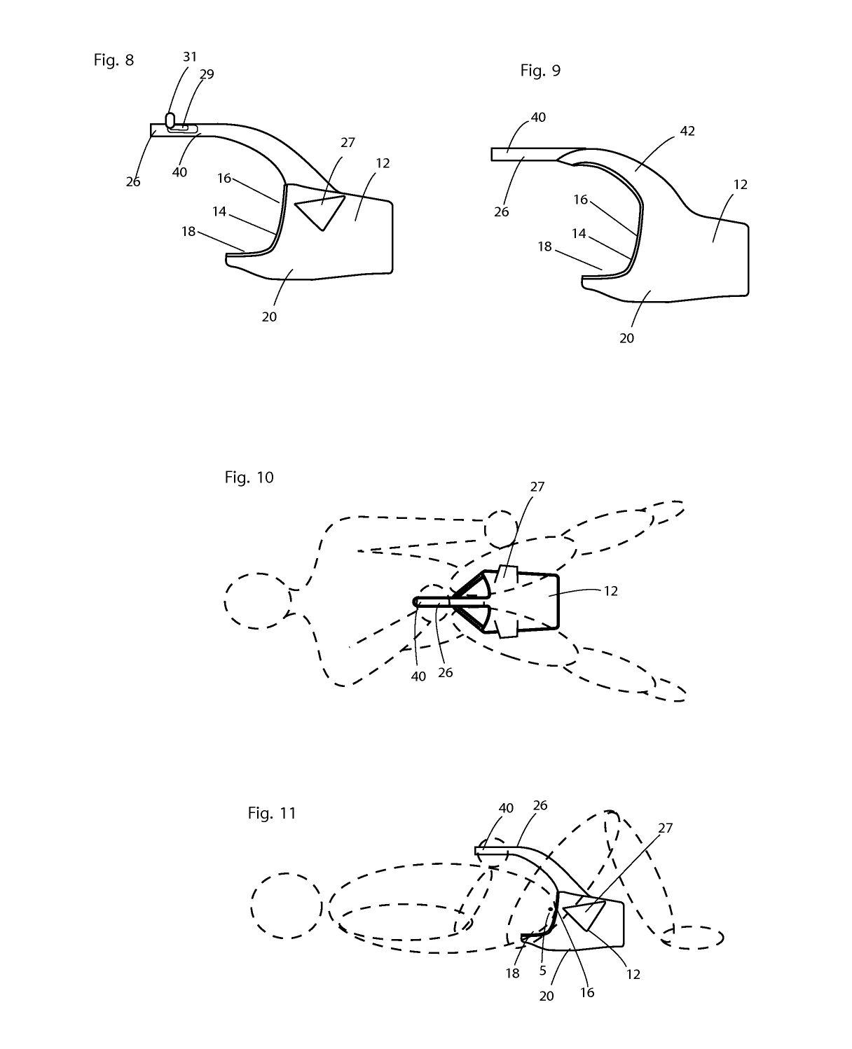

FIG. 8 shows bedpan 10 in which the primary functionality provided by the two handles 26 shown on the sides of reservoir 12 in FIG. 1 is instead provided by a single handle 26 attached to reservoir 12 at the distal side of opening 14, near the upper region of vertical aspect 16. This single handle 26 may also be referred to as central handle 40. Handle 26 may be described as elongated, extruded or “stick like.” Handle 26 shall be dimensioned to be graspable by the user during defecation and oriented so that the pressure may be applied as described in FIG. 6. In this embodiment, the user will position bedpan 10 at his own buttocks using central handle 40, to the location shown in FIGS. 10 and 11. A leg-oriented pressure surface 27 is here embodied as lateral protrusions from reservoir 12.

FIG. 9 shows an embodiment which includes urination extension feature 42 which protrudes upwards and forward from the top of vertical aspect 16, thereby covering at least some of the genital area of a user. Liquids expelled from the genitals are therefore channeled into reservoir 12, and/or bag 30. In this embodiment, the user will orient bedpan 10 with central handle 40, as shown in FIGS. 10 and 11. Central handle 40 and urination extension feature 42 may be integrated.

FIG. 10 shows a top view of a user using a self-administered bedpan with central handle 40.

FIG. 11 shows a side view of a user using a self-administered bedpan with central handle 40. By pressing his legs downwards on pressure surface 27, the user causes bedpan 10 to rotate about horizontal aspect 18, thereby displacing the furthest portion of reservoir 12 downwards, and lowering collection region 20 with respect to horizontal aspect 18.

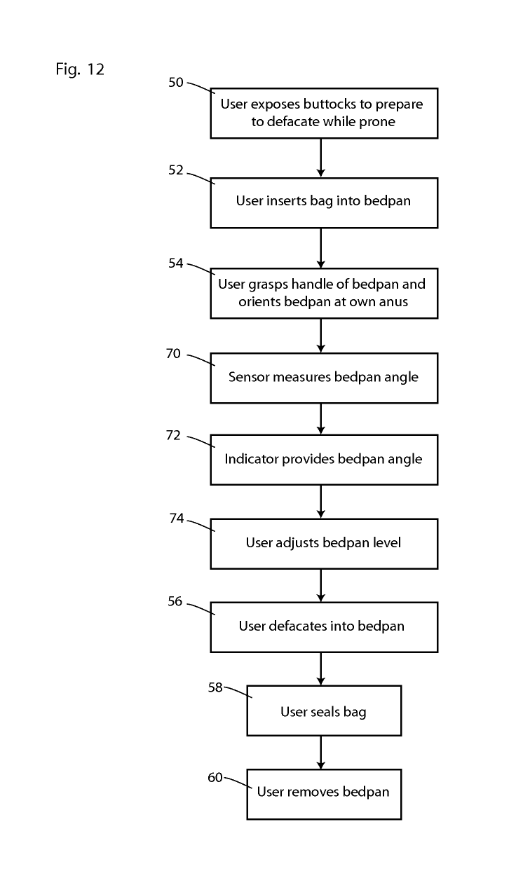

FIG. 12 shows a flow chart of a user using a self-administered bedpan 10. In step 50, the user exposes his buttocks in preparation to defecate while lying down. In step 52, the user places a disposable bag 30 into bedpan 10. In step 54, the user grasps the device by handle 26 or 40 and orients bedpan 10 such that opening 14 is disposed around his anus and lower aspect 18 is located below his sacrum. The uppermost portion of vertical aspect 16 will be above the anus. Typically, the user will position embodiments with one or two lateral handles by lifting one leg and sliding the device in laterally. Embodiments with a central handle 40 will be positioned from the top, lowering the device between the user's legs. This process may be repeated several times before the user defecates, thereby providing one of the advantages of the instant invention because the bedpan does not need to remain in place for long periods of time. When the user places weight upon lower aspect 18, it can cause the opposite end of bedpan 10 to raise upwards, rotating the device with respect to gravity. In some embodiments, an angle sensor 29 is used to measure the orientation of bedpan 10 with respect to gravity, and hence whether collection region 20 is oriented correctly: specifically, collection region 20 should be lower than the horizontal aspect 18 of opening 14. Likewise, angle indicator means 31 provides information to the user as to the orientation of the bedpan 10 with respect to gravity. Whether or not there is a feedback means to inform the user of the angle of bedpan 10, the angle of bedpan 10 may be corrected by the user lowering his legs, thereby pressing upon pressure surface 27. In step 56, the user defecates into bag 30, held open by lip 24. At this point in the process the user may pull upwards on handle(s) 26, toward his head, in order to apply small or large pressure, as desired, at any moment throughout the process, thereby receiving the benefit described in FIG. 6. In step 58, the user seals bag 30 while bedpan 10 remains in contact with his buttocks, thereby preventing odors from escaping. In one embodiment, this is achieved with drawstring 34 integrated within disposable bag 30. One such method is described in FIGS. 4 and 5 (sliding slide-able member 38 to pull drawstring 34). Another embodiment uses a ratchet mechanism 33, designed to grip drawstring 34. There are, however, other ways to implement this functionality, such as fashioning a mechanical closure means into the region of lip 24. Preferably, the user may easily actuate the sealing mechanism without needing to move himself or bedpan 10 after defecation and before moving the bedpan 10. In step 60, the user removes the bedpan by reversing the process of step 54. The risk of spillage during the removal process has been vastly reduced because the bag has been sealed in step 58. The user would then proceed to clean himself as needed. If a bag 30 was not used, bedpan 10 will be cleaned. If a bag 30 was used, it will be disposed of, along with the bodily waste, and bedpan 10 may be reused without cleaning.

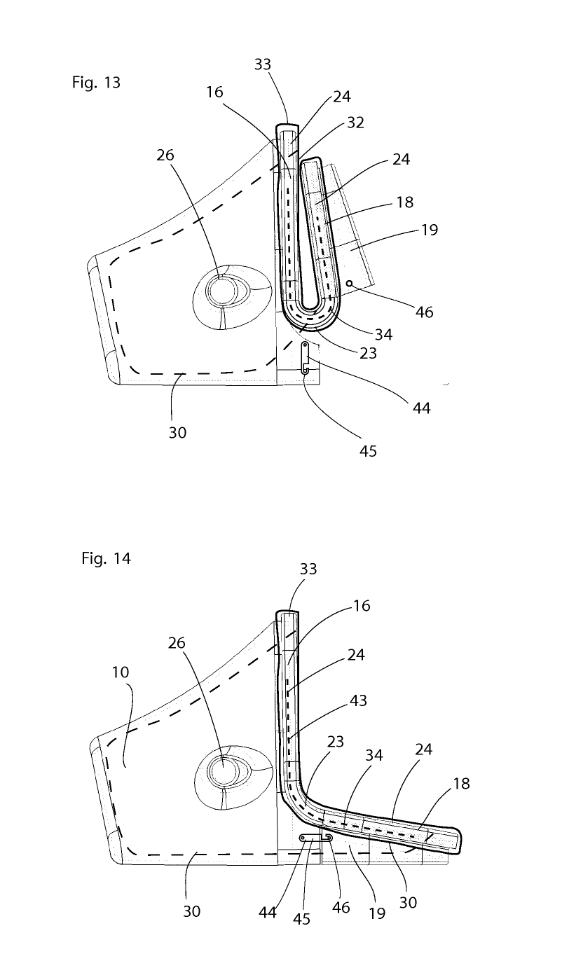

FIG. 13 shows an embodiment in which horizontal aspect 18 is implemented to rotate relative to vertical aspect 16 and to have an associated support structure 19 attached thereto. Lip 24 is molded of an elastomer, such as silicon (durometer approximately 30-60 on the Shore A scale) thereby providing greater comfort to the user by providing a cushioned contact surface. Bend 23 is a portion of lip 24, disposed near its center. Bend 23 acts as a hinge, allowing horizontal aspect 18 (and support structure 19) to rotate upwards relative to vertical aspect 16, to the orientation shown. Lip 24 is manufactured into the shape illustrated in the figure, thereby making this orientation the low-energy state of bedpan 10. In one embodiment, spring 43 (made of a metal such as spring steel) is likewise fashioned into the same shape and disposed beneath lip 24 to provide additional bending force with which to orient horizontal aspect 18 upwards, as shown. Horizontal aspect 18 is therefore spring-loaded, to swing upwards automatically upon release of latch 44. Bag 30 is (shown dashed) inside bedpan 10 with open end 32 held to lip 24 around its circumference by reverse fold 33. In this embodiment, bag 30 does not require drawstring 34.

FIG. 14 shows bedpan 10 prepared for use. Horizontal aspect 18 has been pulled downwards from the orientation of FIG. 13, thereby introducing stress into bend 23 (and/or spring 43). Horizontal aspect 18 is held in this orientation by latch 44, which is itself free to rotate by gravity. Latch 44 includes an upwardly facing hook 45 that engages with pin 46. Bag 30 has been introduced into reservoir 12. Open end 32 is held to lip 24 around its circumference by reverse fold 33. When the user is ready to defecate, he utilizes handles 26 to orient the device as shown in FIGS. 6 and 7 (or FIGS. 9 and 10 in embodiments utilizing a single handle 26). The weight of the user's body, in conjunction with the force applied to vertical aspect 16, bends horizontal aspect 18 downwards (not shown) thereby displacing pin 46 toward the opening of upwardly facing hook 45. When pin 46 reaches the opening of upwardly facing hook 45, latch 44 swings downwards by gravity, to the orientation shown in FIG. 13. Therefore, after the user completes defecation and seeks to remove bedpan 10, horizontal aspect 18 is free to move upwards toward its low-energy state and as the user removes bedpan 10 from the beneath him, horizontal aspect 18 is continually biased upwards (regardless of the orientation of the reservoir 12) thereby preventing spillage of waste material from within reservoir 12. As soon as horizontal aspect 18 is no longer in contact with the body of the user, horizontal aspect 18 closes automatically to the position shown in FIG. 13, thereby closing opening 14 and bag 30.

The details of one or more embodiments of the invention are set forth in the accompanying drawings and the description below. Other features, objects, and advantages of the invention will be apparent from the description and drawings, and from the claims.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A self-administered bedpan useful in association with a user, the bedpan comprising:
a reservoir configured to receive bodily waste of a user; and
at least one handle configured to be grasped by the user.

2. The self-administered bedpan of claim 1 wherein the reservoir includes an opening configured to extend above an anus of the user and further configured to extend below a sacrum of the user.

3. The self-administered bedpan of claim 1 wherein the at least one handle is detachable.

4. The self-administered bedpan of claim 1 wherein the at least one handle includes a first handle protruding from one side of the bedpan and includes a second handle protruding from an opposite side of the bedpan.

5. The self-administered bedpan of claim 1 wherein the at least one handle protrudes outwards from the bedpan and wherein a distal end of the at least one handle is configured not to be proximate to the bedpan.

6. The self-administered bedpan of claim 1 wherein the at least one handle is further configured to adapt to a plurality of orientations with respect to the bedpan thereby enabling the bedpan to be compatible with a plurality of user arm length to user torso length ratios.

7. The self-administered bedpan of claim 1 wherein the at least one handle is configured to allow the user to increase pressure between the bedpan and buttocks of the user by pulling on the at least one handle in a direction substantially towards a head of the user.

8. The self-administered bedpan of claim 1 wherein the at least one handle protrudes from a center of the bedpan and extends in a direction substantially toward a head of the user.

9. The self-administered bedpan of claim 1 further comprising an urination extension configured to channel urine produced by the user into the reservoir.

10. The self-administered bedpan of claim 1 further comprising a tilt sensor configured to measure horizontal orientation of the bedpan.

11. The self-administered bedpan of claim 1 further comprising a self-closing opening configured to close when the user disengages from the bedpan thereby substantially preventing spillage of waste from the reservoir.

12. The self-administered bedpan of claim 11 further comprising a latch configured to cause the self-closing opening of the reservoir to remain in an open position, wherein the self-closing opening is spring-loaded, and wherein the latch is further configured to release when the user engages with the bedpan thereby enabling the self-closing opening to close when the user disengages from the bedpan.

13. The self-administered bedpan of claim 1 further comprising a disposable waste bag.

14. The self-administered bedpan of claim 13 wherein the bag is configured to transition from a substantially open state to a substantially sealed state while an opening of the reservoir is in substantial contact with buttocks of the user.

15. The self-administered bedpan of claim 13 further comprising a seal activating mechanism configured to facilitate sealing of the bag.

16. A disposable waste bag useful in association with a self-administered bedpan having a waste reservoir and at least one elongated handle configured to be grasped by a user, the waste bag comprising:
a bag body configured to be installed substantially inside a reservoir of the self-administered bed pan, wherein the reservoir is configured to receive bodily waste of a user; and
a bag opening configured to conform with a corresponding opening of the bedpan configured to extend above an anus of the user and further configured to extend below a sacrum of the user.

17. The disposable waste bag of claim 16 further comprising a closable opening including a tension member disposed about the opening.

18. A method for a user to collect bodily waste while remaining in a prone position, useful in association with a self-administered bedpan, the method comprising:
grasping at least one elongated handle of a self-administered bedpan using a hand of a user, and orienting an opening of the bedpan toward an anus of the user;
defecating into the bedpan; and
grasping at least one elongated handle of the self-administered bedpan using the hand of the user, and disengaging the bedpan from the user.

19. The method of claim 18 further including closing a disposable bag having defecated material prior to or contemporaneous with disengagement of the bedpan from the user.

20. The method of claim 18 further including the user pulling on at least one elongated handle during defecation to increase pressure between the opening and a buttock of the user.
